(19) United States
(12) Patent Application Publication
(10) Pub. No.: US 2004/0179234 A1
(43) Pub. Date: Sep. 16, 2004

(54) Network terminal apparatus

(75) Inventor: Akihiro Yoshitani, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/798,316

(22) Filed: Mar. 12, 2004

(30) Foreign Application Priority Data
Mar. 14, 2003 (JP) 2003-070596

(51) Int. Cl. G06F 15/00

(52) U.S. Cl. 358/1.15

(57) ABSTRACT

Disclosed is a facsimile apparatus for presenting a display without waiting for the entirety of an image to be received. To achieve this the apparatus includes a display for displaying a bitmap image, a receiver for receiving data from a network, an expanding unit for expanding compressed image data, a creating unit for creating preview image data based upon the image data, and a controller which, when the compressed image data is received by the receiver, is for causing the expanding unit to expand a portion of the received image data even before all compressed image data is received, causing the creating unit to create preview image data based upon the expanded image data, and causing the display to display the preview image data. Also disclosed is a facsimile apparatus that includes a receiver for receiving facsimile data from a telephone line, a decoder for sequentially decoding a portion of image data that corresponds to received facsimile data whenever a fixed amount of facsimile data constituting part of an image is received by the receiver, a generator for generating reduced-size image data corresponding to the portion of the image data decoded, a display for displaying the reduced-size image based upon the generated reduced-size image, and a printer for printing out facsimile data, which corresponds to the reduced-size image displayed on the display, if a print command has been entered.

### FIELD OF THE INVENTION

This invention relates to a network terminal apparatus, such as a facsimile machine having a display unit, which makes it possible to view and print image data that has been received via a communication line.

### BACKGROUND OF THE INVENTION

A facsimile machine according to the prior art has a display device that is capable of displaying a bitmap image and can present a preview display of a received image on the bitmap-image display screen before the received image is printed. With such a facsimile machine, the received image is stored temporarily in a memory or the like. By observing the preview screen on which the received image is displayed, the operator can specify an image that is to be printed or an image that is to be discarded without being printed.

Because an image of reduced size for the purpose of preview is created after receive processing ends in this conventional facsimile machine, the content of a received image cannot be displayed until the image data of the single image is received in its entirety. Consequently, a certain period of time is required from the start of preview processing to the moment the preview display actually appears. As a result, the operator can view the preview image only after the facsimile machine has received the entire image and only then can determine whether or not to print the image.

### SUMMARY OF THE INVENTION

Accordingly, an object of the present invention is to provide a network terminal apparatus in which received image data is subjected to decoding and size reduction concurrently while reception of the image data is in progress, and the reduced image created is displayed sequentially as each part of the image is created, thereby making it possible to present a preview display in rapid fashion so that printing can be started in response to a request from the user even while the preview display is in the process of being presented.

According to the present invention, the foregoing object is attained by providing a network terminal apparatus comprising a display for displaying a bitmap image; a receiver for receiving data from a network; an expanding unit for expanding compressed image data; a creating unit for creating preview image data based upon the image data; and a controller which, when the compressed image data is received by the receiver, is for causing the expanding unit to expand a portion of the received image data even before all compressed image data is received, causing the creating unit to create preview image data based upon the expanded image data, and causing the display to display the preview image data.

Preferably, according to the present invention, whenever a fixed amount of the compressed image data is received, the controller causes the expanding unit to execute expansion processing sequentially, causes the creating unit to create preview image data based upon the expanded image data and causes the display to sequentially display the preview image data created.

Preferably, according to the present invention, the network terminal apparatus further comprising a printing unit capable of printing image data.

According to another aspect of the present invention, a facsimile apparatus comprises a receiver for receiving facsimile data from a telephone line; a decoder for sequentially decoding a portion of image data that corresponds to received facsimile data whenever a fixed amount of facsimile data constituting part of an image is received by the receiver; a generator for generating reduced-size image data corresponding to the portion of the image data decoded; a display for displaying the reduced-size image based upon the reduced-size image generated; and a printer for printing out facsimile data, which corresponds to the reduced-size image displayed on the display, if a print command has been entered.

Preferably, if the print command has been entered while part of the reduced-size image data generated by the generator is being displayed on the display, the printer prints out facsimile data corresponding to the reduced-size image being displayed.

Thus, in accordance with the present invention, encoded image data is subjected to decoding and scaling concurrently while it is being received and the image can be displayed as each part of the image is received. As a result, the operator can start display of the image without waiting for the entire image to be received.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is a block diagram illustrating the internal structure of a facsimile machine according to an embodiment of the present invention;

FIG. 2 is a diagram illustrating the structure of a memory within the facsimile machine of this embodiment;

FIG. 3 is a flowchart illustrating expansion processing and preview-image creation processing executed when image data is received in the apparatus of this embodiment; and

FIGS. 4A to 4E are diagrams illustrating, in the form of a time series, the content of each buffer shown in FIG. 2 when image data is received in the apparatus of this embodiment.

### DETAILED DESCRIPTION OF THE PREFERRED EMBODIMENT

A preferred embodiment of the present invention will now be described with reference to the drawings.

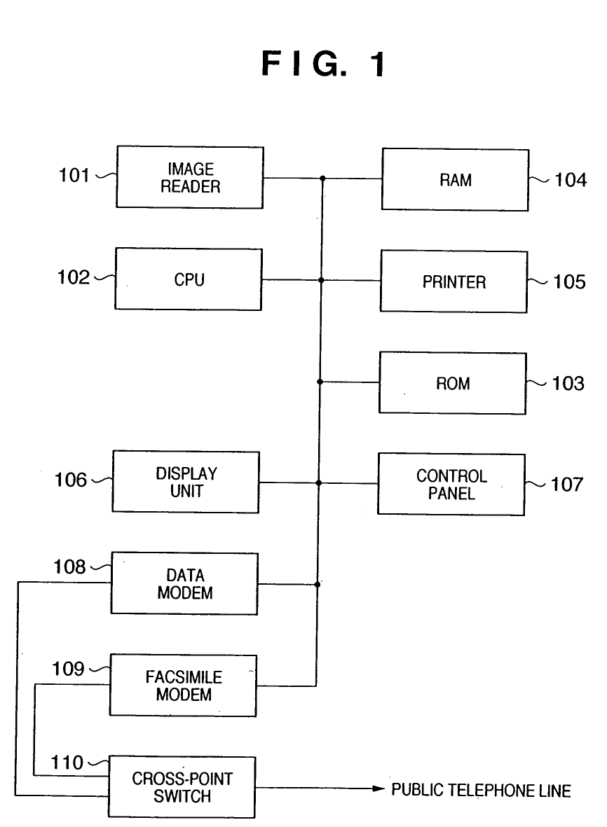

FIG. 1 is a block diagram illustrating the internal structure of a facsimile machine according to an embodiment of the present invention. As shown in FIG. 1, the facsimile machine includes an image reader 101 for optically reading a document and converting it to image data. A CPU 102 performs overall control of the facsimile machine, a ROM 103 stores the operating program of the CPU 102, and a RAM 104 functions as a working memory of the CPU 102 and stores received data. A printer 105 prints image data that has been read by the image reader 101 or been received via a communication line. A display unit 106 is capable of displaying a bitmap image, and a control panel 107 has a keypad, etc., by which a user operates the facsimile machine using keys or the like. A data modem 108 sends and receives binary data via a communication line, and a facsimile modem 109 sends and receives facsimile images via the communication line. Data that has been received from the communication line is divided between the data modem 108 and the facsimile modem 109 by a cross-point switch 110.

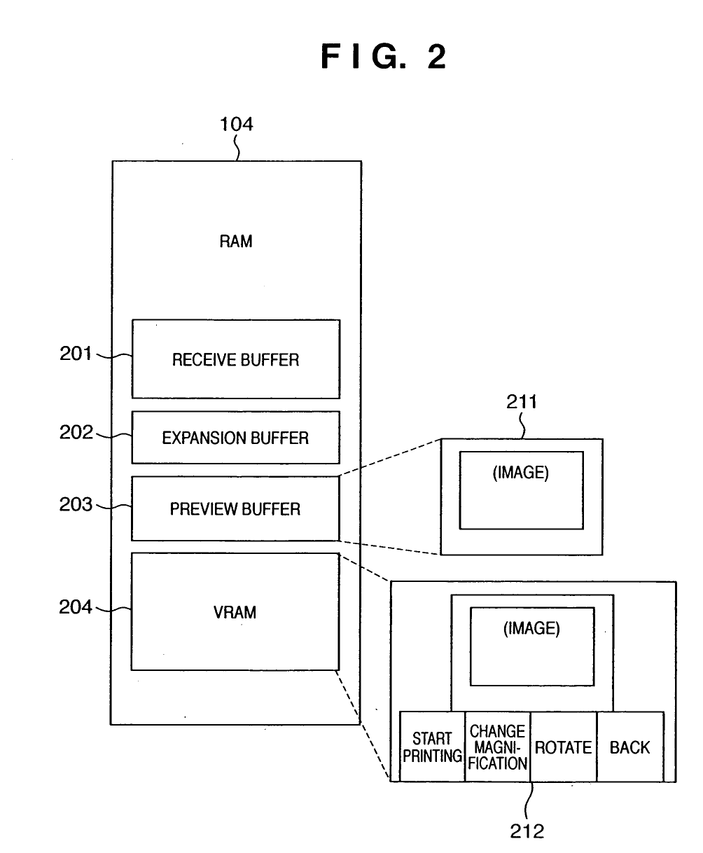

FIG. 2 illustrates part of the memory structure of the facsimile machine according to this embodiment.

Various areas are reserved in the memory of RAM 104. These are a receive buffer 201 for storing compressed image data that has been received, an expansion buffer 202 for expanding received image data and storing the results, a preview buffer 203 for storing compressed image data for preview, and a VRAM 204 for storing image data representing an image displayed on the display unit 106.

FIG. 2 depicts an example in which reduced-size image data 211 has been written to the preview buffer 203 and image data 212 to the VRAM 204. In this embodiment, where it is assumed that a printout is on paper of a fixed size, e.g., size A4, the image data 212 includes an image of reduced size corresponding to the image on the entire sheet of paper, and button images for allowing an operator to enter commands regarding the received image that corresponds to the reduced-size image. In the example of FIG. 2, the button images include buttons for specifying “START PRINTING”, “CHANGE MAGNIFICATION”, “ROTATE” and “BACK”. It should be noted, however, that the types of buttons displayed and the number of buttons can be increased or decreased depending upon the functions of the facsimile machine.

The VRAM 204 is an area for storing the bitmap image displayed on the display unit 106. The display unit 106 reads out data, which has been stored in the VRAM 204 at regular intervals, and displays the image that conforms to this data. Accordingly, in order to display a specific image, it will suffice to write the bitmap image corresponding to this image to the VRAM 204. Since the image data 212 has been written to the VRAM 204 in FIG. 2, an image corresponding to the image data 212 is displayed.

The expansion buffer 202 need not have a size capable of storing the entirety of the received image data. The reason is that in this embodiment, image data expansion is not performed after all of the compressed image data from a telephone line is received; rather, expansion processing is executed in part whenever a certain size of the compressed image data is received. As a matter of course, however, the capacity of the expansion buffer 202 may be made large enough to allow storage of the entire received image. If this arrangement is adopted, then, in a case where printing of an image is specified, image data that has been stored in the expansion buffer 202 can be used for printing as is without executing expansion processing afresh.

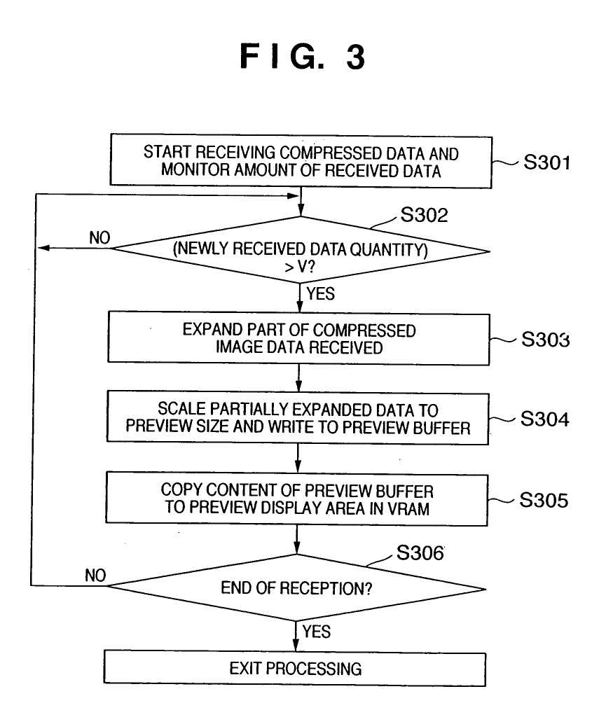

FIG. 3 is a flowchart illustrating processing executed when the facsimile machine of this embodiment receives image data. The procedure of FIG. 3 is processing executed by the CPU 102 and does not include autonomous processing by the display unit 106, by way of example.

According to this embodiment, it is assumed that resolution that prevails when a received image data is printed has been predetermined to be a fixed value m (dpi). In the case of a color facsimile machine, for example, m=200 dpi. However, it is possible to utilize a resolution given by the destination of communication via a telephone line or a resolution given by data that has been entered from the control panel 107.

The processing of FIG. 3 proceeds as follows:

S301: Reception of the compressed image data starts. The received data is either facsimile data received via the facsimile modem 109 or binary image data (image data on the Internet, etc.) received via the data modem 108. Monitoring of amount X (bytes) of the received data also begins at step S301. The processing for receiving data is itself executed in parallel with a process different from that of FIG. 3. The data quantity X is implemented as a variable reserved in RAM 104, for example, and the amount of data received by data receive processing is accumulated.

S302: If the data quantity X is greater than a fixed Value V, control proceeds to step S303. If the data quantity X is equal to or less than V, the apparatus waits for the data quantity X to become V or for data reception to end.

S303: The compressed image data of size X received thus far is expanded and then stored in the expansion buffer 202. As a result, n lines (where n varies depending upon the data) of uncompressed image data can be stored in the expansion buffer 202.

S304: The n-line image in expansion buffer 202 is scaled at a scaling factor p (described later) and the result of scaling is written to the preview buffer 203. In this case, if image data that has been expanded in the expansion buffer 202 is not at the head of one image, then the newly scaled image data is written to the preview buffer 203 so as to connect to the tail end of the image data that has already been stored in the preview buffer 203. On the other hand, if image data that has been expanded in the expansion buffer 202 is at the head of one image, then the newly scaled image data is written to the preview buffer 203 starting from the leading end thereof. The “leading end” of the preview buffer 203 mentioned here need not necessarily be the leading end physically and may be the leading end logically. As a result of the above operation, n×p lines of image data are added to the preview buffer 203 anew.

S305: The data in the preview buffer 203 is transferred to the VRAM 204. The preview image of reduced size which is the part of the received compressed image data received thus far can be previewed on the display screen of the apparatus of this invention. However, as mentioned above, this embodiment is such that operating buttons also are displayed on the preview screen besides the reduced image for preview. The data representing the reduced-size preview image, therefore, is written to the area, which has been reserved in VRAM 204, that is for the reduced-image data. As a result, borders and button images other than the received image continue to be displayed without being changed.

S306: It is determined whether reception of the image data has ended. If reception of image data ends at this point, then processing is exited. That is, if processing has branched to step S303 at step S302 owing to end of the image data, then processing is terminated. If reception of image data representing the next image is then started, the processing of FIG. 3 is executed.

On the other hand, if it is found at step S306 that reception of image data has not ended, then the value of the data quantity X is restored to zero and control proceeds to step S302.

It should be noted that when the scaled image is written to the preview buffer 203 at step S304, it is necessary to determine whether the data that is to be written corresponds to the head of the received image. To achieve this, a flag indicative of the beginning part of the image is set at step S301 and the flag is reset at step S305, by way of example. Thus, if the flag is found to have been set at the time of step S304, then it can be determined that the data about to be written at this time is the data at the beginning of the image.

The scaling factor p will now be described. If we let the number of dots in the horizontal direction of the received image be represented by Rx, then the size of the received image in the horizontal direction when the image has been printed will be Rx/m inches. If the preview buffer has a capacity for storing an image of Ax dots horizontally×Ay dots vertically and the number of dots is made to correspond to image data of size A4 (8.3×11.7 inches), then the number Gx of dots in the horizontal direction of the reduced image for previewing the image whose number of dots in the horizontal direction is Rx will be given by the following equation: Gx=Ax·Rx/8.3 m. The scaling factor p, therefore, is expressed by the following equation: p=Gx/Rx=Ax/8.3 m.

The scaling factor p is a value that is for fitting the image data of size A4 in the preview buffer 203 exactly without capacity being left over. This means that if image data having a size other than size A4 is received, the buffer capacity will be inadequate or will not all be used. In a case where the size of the received image is greater than size A4 and the capacity of the preview buffer 203 is inadequate, the entire image is not used as the preview image. For example, it will suffice if part of the decoded image data is scaled and used as the preview image.

Further, instead of making the scaling factor p a fixed value as set forth above, it can be changed in dependence upon the number Rx of dots in the horizontal direction of the received image. By adopting this expedient, image data that has been scaled at the scaling factor p can be stored in the preview buffer 203 exactly without capacity being left over irrespective of the size of the received image. In this case, the scaling factor p would be given by the equation

p=Ax/Rx.

Next, as one example, the states of the receive buffer 201, expansion buffer 202, preview buffer 203 and VRAM 204 with the passage of time will be described in detail in accordance with FIG. 3.

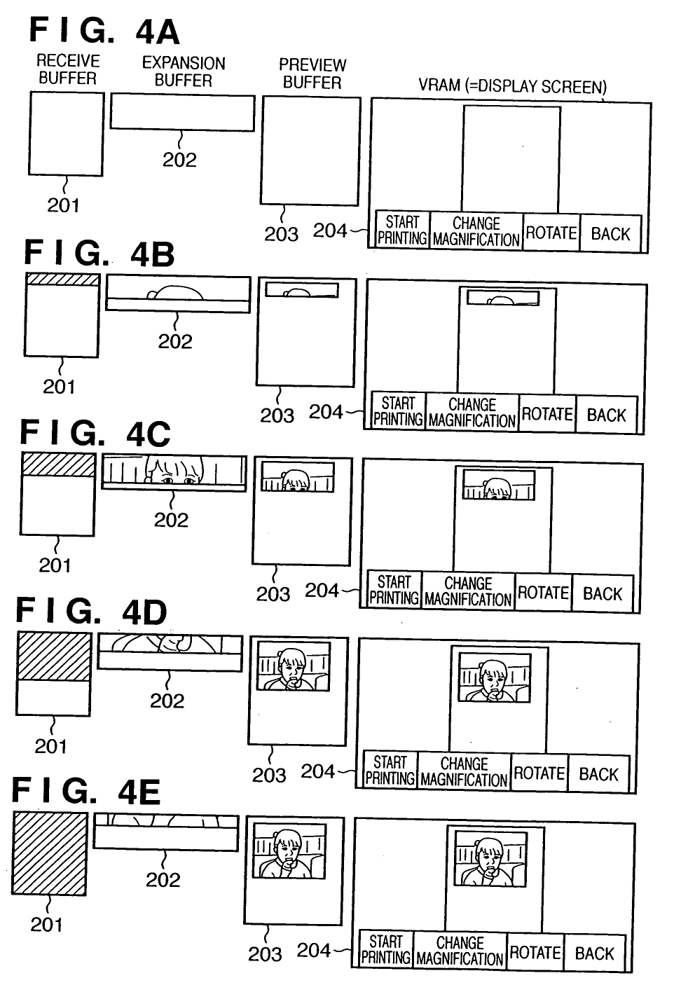

The initial states of these buffers are as shown in FIG. 4A, i.e., the buffers are empty. It will be assumed that borders and images other than a preview image have already been stored in the VRAM 204. The description will start from this state with reference being had to the procedure of FIG. 3.

(1) Reception of data is started. The amount X (bytes) of data received is monitored constantly.

(2) When the received data quantity X exceeds V the first time, then expansion of the data received thus far begins (S302). As a result of expanding V bytes of the received data, n lines of the image are expanded in the expansion buffer 202 (S303). The n-line image is scaled at the scaling factor p and a reduced image of

n×p lines obtained as a result is written to the preview buffer 203 (S304). All of the data in the preview buffer 203 is transferred to the preview display area of the VRAM 204. Hence, a preview image is presented of the part of the received image that has been written to the VRAM 204 (S305). As a result, first the initial n×p lines are displayed, as shown in FIG. 4B.

(3) When the next V bytes are received, these newly received V bytes of data are subjected to expansion, scaling at the scaling factor p and transfer to the VRAM 204 in a manner similar to (2) above. The expansion buffer 202 is employed starting from the leading address thereof every V bytes, whereas the preview buffer 203 stores data by appending it to the address that follows the image that was written to the buffer previously.

(4) If the processing of (3) above is repeated every V bytes, the preview image is gradually completed on the display screen as image receive processing proceeds, as indicated on the right side of FIGS. 4C and 4D.

(5) When reception ends, processing similar to that of (2) above is applied to the last of the received image data that remains, thereby finally completing the preview image (FIG. 4E).

By virtue of the structure and operation described above, a receiving terminal apparatus such as a facsimile machine for receiving externally applied image data executes processing for expanding and scaling the amount of image data received at any time and displaying it on a display screen while the amount of received image data is monitored. As a result, the user is capable of previewing the received image data quickly before the reception of the image data ends.

Accordingly, the user of the facsimile machine can check the received image on the display screen of the apparatus before reception ends.

There are occasions where document data to be received by facsimile transmission has content that makes it possible to determine, without viewing the entire document, whether the document should be printed or not. For example, there are cases where the content of document data having a title or header can be inferred by observing the title or header. Further, with regard to a pictorial image, there are case where the entire image can be ascertained from a portion thereof. In such cases the operator, by viewing the preview image of image data while the image data is being received, can specify whether to print or discard the image at an early time (while reception is in progress).

Thus, in accordance with the present invention as described above, encoded image data is subjected to decoding and scaling concurrently while it is being received, and the image can be displayed as each part of the image is received. As a result, the operator can start display of the image without waiting for the entire image to be received.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

What is claimed is:

1. A network terminal apparatus comprising:
a display for displaying a bitmap image;
a receiver for receiving data from a network;
an expanding unit for expanding compressed image data;
a creating unit for creating preview image data based upon the image data; and
a controller which, when the compressed image data is received by said receiver, is for causing said expanding unit to expand a portion of the received image data even before all compressed image data is received, causing said creating unit to create preview image data based upon the expanded image data, and causing said display to display the preview image data.

2. The device according to claim 1, wherein whenever a fixed amount of the compressed image data is received, said controller causes said expanding unit to execute expansion processing sequentially, causes said creating unit to create preview image data based upon the expanded image data and causes said display to sequentially display the preview image data created.

3. The device according to claim 1, further comprising a printing unit capable of printing image data.

4. A method of controlling a network terminal apparatus having a display for displaying a bitmap image and a receiver for receiving data from a network, said method comprising:
an expanding step of expanding compressed image data, which has been received by said receiver, sequentially from the portion of the data received;
a creating step of creating preview image data sequentially based upon the expanded image data; and
a display step of displaying the preview image data sequentially by said display.

5. The method according to claim 4, wherein said expanding step executes expansion processing sequentially whenever a fixed amount of the compressed image data is received.

6. The method according to claim 4, further comprising a printing step of printing expanded image data by a printer engine.

7. A computer program product that includes a recording medium storing a program implemented by a network terminal apparatus having a display for displaying a bitmap image and a receiver for receiving data from a network, said program including:
code of an expanding step of expanding compressed image data, which has been received by said receiver, sequentially from the portion of the data received;
code of a creating step of creating preview image data sequentially based upon the expanded image data; and
code of a display step of displaying the preview image data sequentially by said display.

8. The computer program product according to claim 7, wherein said code of the expanding step executes expansion processing sequentially whenever a fixed amount of the compressed image data is received.

9. The computer program according to claim 7, further comprising code of a printing step of printing expanded image data by a printer engine.

10. A facsimile apparatus comprising:
a receiver for receiving facsimile data from a telephone line;
a decoder for sequentially decoding a portion of image data that corresponds to received facsimile data whenever a fixed amount of facsimile data constituting part of an image is received by said receiver;
a generator for generating reduced-size image data corresponding to the portion of the image data decoded;
a display for displaying the reduced-size image based upon the reduced-size image generated; and
a printer for printing out facsimile data, which corresponds to the reduced-size image displayed on said display, if a print command has been entered.

11. The apparatus according to claim 10, wherein if the print command has been entered while part of the reduced-size image data generated by said generator is being displayed on said display, said printer prints out facsimile data corresponding to the reduced-size image being displayed.

12. A method of controlling a facsimile apparatus, comprising:
a receiving step of receiving facsimile data from a telephone line a fixed amount at a time;
a decoding step of decoding the facsimile data and generating bitmap image data whenever a fixed amount of facsimile data is received at said receiving step;
a reducing step of reducing the bitmap image data generated at said decoding step;
a display step of displaying a reduced-size image based upon reduced-size image data obtained at said reducing step; and
a printing step of printing out facsimile data, which corresponds to the reduced-size image displayed at said display step, if a print command has been entered.

13. A computer program product that includes a recording medium storing a program for controlling a facsimile apparatus, said program comprising:
code of a receiving step of receiving facsimile data from a telephone line a fixed amount at a time;
code of a decoding step of sequentially decoding the facsimile data and generating bitmap image data whenever a fixed amount of facsimile data is received by the code of said receiving step;
code of a reducing step of reducing the bitmap image data generated by the code of said decoding step;
code of a display step of displaying a reduced-size image based upon reduced-size image data obtained by the code of said reducing step; and
code of a printing step of printing out facsimile data, which corresponds to the reduced-size image displayed by the code of said display step, if a print command has been entered.
